(19) United States
(12) Patent Application Publication
(10) Pub. No.: US 2007/0078788 A1
(43) Pub. Date: Apr. 5, 2007

(54) Content recording method and system, media label distribution method and system, and media label distribution system

(76) Inventor: Yuji Iwakiri, Kyoto (JP)

Correspondence Address: MCDERMOTT WILL & EMERY LLP, 600 13TH STREET, N.W., WASHINGTON, DC, 20005-3096, US

(21) Appl. No.: 11/520,687

(22) Filed: Sep. 14, 2006

(30) Foreign Application Priority Data
Oct. 4, 2005 (JP) 2005-291006
Jul. 3, 2006 (JP) 2006-183237

(51) Int. Cl. G06Q 99/00

(52) U.S. Cl. 705/76

(57) ABSTRACT

A content purchase certificate and the like is embedded together with content data to an optical disc such as a DVD or the like so as not to involve any influence on a reproduction operation. Identification by referencing the content purchase certificate is performed in a content management center connected to a PC via an external network such as the Internet or the like, so that media label data is allowed to be printable.

### CROSS-REFERENCE TO RELATED APPLICATIONS

This nonprovisional application claims priority under 35 U.S.C. §119(a) on Japanese Patent Applications No. 2005-291006 filed on Oct. 4, 2005 and No. 2006-183237 filed on Jul. 3, 2006, and the entire contents disclosed in the specification, drawings and claims of this application are hereby incorporated by reference.

### BACKGROUND OF THE INVENTION

The present invention relates to a media label distribution system capable of efficient distribution of media label data to purchasers of contents.

Conventionally, an end user who purchased a content such as a pay broadcast program or the like can have a desire to record the content in a printable disc such as a CD, a DVD, or the like, and thereafter print media label data including information about the content on a label surface of the printable disc. In this case, conventionally, the user needs to search through the Internet and the like, for media label data suitable to the content or needs to find a material suitable to the content and create a label from the material by him/herself.

When such media label data itself is on the Internet, or the like, the media label data is possibly available on a copyright-free basis after abandonment of the copyright by the copyright owner, or the media label data itself is possibly on sale by the copyright owner.

In such cases, the user needs to pay for the media label data itself or needs to create a media label by him/herself. However, even if the media label data is solely on sale, the user may not dare to buy it for money. On the other hand, creating the label by him/herself costs the user some efforts.

For copyright-free media labels, copyright owners must abandon their rights. Also, for sale of media labels, copyright owners must provide some means for solely distributing media labels besides sale of their contents such as a pay broadcast program. Thus, creation and distribution of media label data is difficult to be brought into conformity with the sale of their contents.

Japanese Patent Application Laid Open Publication No. 2000-36781A discloses a technique for realizing appropriate copyright fee payment corresponding to the conditions of use of a copyrighted work in a system for distributing copyrighted work data.

FIG. 7 is a block diagram showing a configuration of a conventional copyrighted work distribution/receiving system. As shown in FIG. 7, the copyrighted work distribution/receiving system includes a distributor 15 for distributing a TV program or the like, a ground station 16 for receiving the TV program or the like from the distributor 15 and transmitting it by radio waves from its antenna to a satellite 17, the satellite 17 for broadcasting the TV program or the like transmitted from the ground station 16, a receiving facility 18 for receiving the TV program or the like broadcasted from the satellite 17, a telephone line 19 for allowing the receiving facility 18 to transmit fee information, and a customer management center 20 to be connected to the receiving facility 18 through the telephone line 19, wherein the receiving facility 18 includes a receiver 18a and a storage 18b for recording the TV program or the like received by the receiver 18a.

The distributor 15 distributes the TV program or the like via the ground station 16 and the satellite 17. A user who is to receive a broadcast program receives the TV program or the like and a jacket image of the TV program or the like via the receiver 18a of the receiving facility 18 and records it to the storage 18b. Then, he/she transmits audio-visual information thereof to the customer management center 20 through the telephone line 19. In response, the customer management center 20 sends a bill to the user.

### SUMMARY OF THE INVENTION

Japanese Patent Application Laid Open Publication No. 2000-36781A, however, fails to disclose a media label distribution method. Also, the disclosed technique involves wasteful occupation of the broadcast band because the jacket image or the like is piggybacked on the broadcast waves for transmission.

The present invention has been made in view of the foregoing and has its object of realizing efficient distribution of media label data for content purchasers.

Specifically, the present invention provides a media label distribution system including: means for receiving content data; means for transmitting a content purchase certificate indicating that the received content data has been purchased to a content management center via an external network; means for providing printing permission of media label data for the content data to a user identified as a purchaser of the content data by referencing the content purchase certificate in the content management center; means for recording the content data to a content recording medium; and means for printing the media label data on a label surface of the content recording medium.

According to the present invention, the content purchase certificate and the like indicating that a user has purchased the content data is embedded as data in an optical disc such as a DVD or the like so as not to involve any influence on a reproduction operation, and user identification is performed by referencing the content purchase certificate in an environment capable of being connected to an external network such as the Internet or the like, whereby the user is allowed to print the media label data. This enables provision of added value including media label data to the user at content purchase. Further, sale and distribution of objects relating to contents can be controlled in addition to control of the contents themselves, so that the copyright owners can distribute their services without unnecessarily occupying the broadcast band, which increases the range of availability of service provision.

Further, in the present invention, whether the media label data or the media jacket file is distributed on fee basis or fee-free basis can be presented as an index for determination as to whether to purchase a content in addition to the details of the content at user's content purchase, resulting in enhancement of user's convenient.

In the present invention, after purchase of a content, the user records the content to an optical disc or the like. When the user references a purchase history in the content management center through an external network such as the Internet or the like, he/she is identified as a purchaser of the content and obtains printing permission of the media label data, whereby he/she is allowed to print the media label data for the content that he/she purchased.

Furthermore, in the present invention, copyright owners can present, not through media, printing availability of media label data as added value in distribution/sale of contents such as a pay broadcast program and the like, obtaining an effect advantageous on promotion of the content distribution/sale.

### BRIEF DESCRIPTION OF THE DRAWINGS

FIG. 1 is a block diagram showing a configuration of a media recording system which composes a media label distribution system according to Embodiment 1 of the present invention.

FIG. 2 is a block diagram showing a configuration of a media label printing system which composes the media label distribution system according to Embodiment 1 of the present invention.

FIG. 3 is a flowchart showing a processing operation of the media label printing system.

FIG. 4 is a flowchart showing a software algorithm in a content management center.

FIG. 5 is a block diagram showing a configuration of a media label distribution system according to Embodiment 2 of the present invention.

FIG. 6 is a diagram illustrating a composition of content data to be recorded to an optical disc.

FIG. 7 is a block diagram showing a configuration of a conventional copyright work distribution/receiving system.

### DESCRIPTION OF THE PREFERRED EMBODIMENTS

Embodiments of the present invention will be described below with reference to the accompanying drawings. The following description of the preferred embodiments is mere substantial examples and is not intended to limit the present invention, applicable objects, and use thereof.

(Embodiment 1)

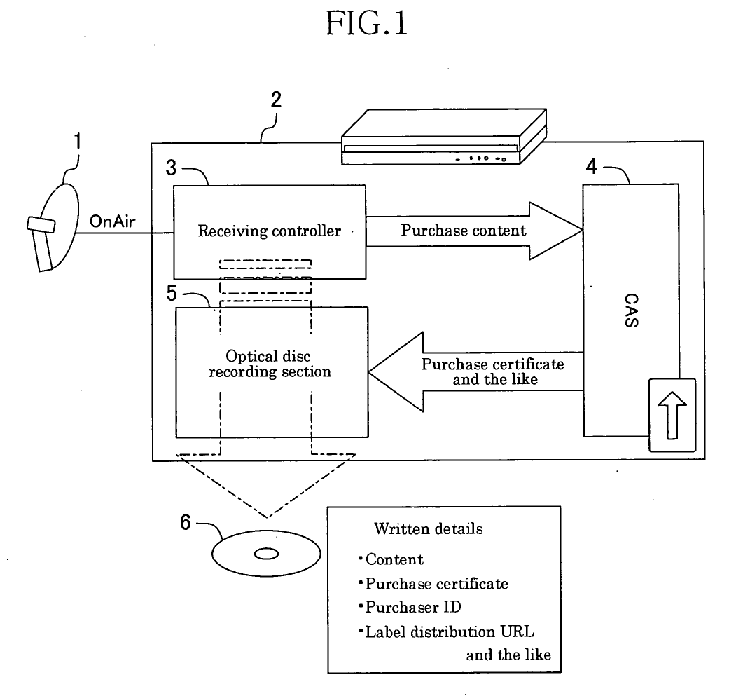

FIG. 1 is a block diagram showing a configuration of a media recording system which composes a media label distribution system according to Embodiment 1 of the present invention. In FIG. 1, reference numeral 1 denotes a broadcast wave receiver (an antenna) for receiving a digital broadcast program as broadcast program data, wherein the broadcast program data received is input as content data into a recorder 2 for performing recording to an optical disc 6 such as a DVD or the like.

The recorder 2 includes a receiving controller 3 for receiving digital broadcast data from the broadcast wave receiver 1, a CAS (Conditional Access System) 4 for allowing only a subscriber of a pay broadcast program to enable to view and listen the pay broadcast program, and an optical disc recording section 5 for recording to the optical disc 6 content data, a content purchase certificate, a purchaser ID, a label distribution URL, and the like.

In the recorder 2, the receiving controller 3 extracts, from the received pay broadcast program, key information of the pay broadcast program and transmits it to the CAS 4 for descrambling the key information.

When the key information is obtained through receipt of the pay broadcast program and transmission of the key information to the CAS 4, a response thereof is held which indicates that purchase of the pay broadcast program and media label data therefor has been done. In recoding to the optical disc 6, the response as a content purchase certificate and a media label purchase certificate is recorded to the optical disc 6 together with the content data so as not to involve any influence on reproduction of any data in the optical disc 6.

Specifically, referring to the standard of the ARIB (Association of Radio Industries and Businesses) in Japan as an example, as shown in FIG. 6, it is preferred that the content purchase certificate and/or the media label purchase certificate is/are concealed in a padding packet or the like by pretending to be an ES (Elementary Stream) in the content data to be recorded in the optical disc 6, rather than direct recording thereof in a file format or the like. Desirably, the content purchase certificate and/or the media label purchase certificate to be recorded is/are encrypted.

When the content purchase certificate and the media label purchase certificate are embedded in a range within a predetermined number of bytes from the top of a content file of the content data, they can be readily found out by searching only the predetermined bytes from the top of the content film at data reading.

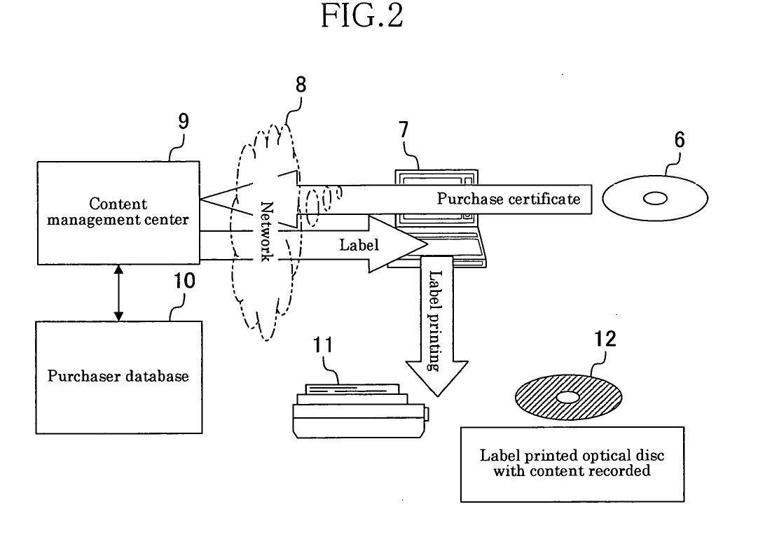

FIG. 2 is a block diagram showing a configuration of a media label printing system which composes the media label distribution system in the present embodiment. In FIG. 2, a PC 7 is capable of being connected to a network and has an identification drive to which the optical disc 6 is to be inserted, wherein the content data, the content purchase certificate, the media label purchase certificate, and the like are recoded in the optical disc 6 by the recorder 2.

The PC 7 connected to an external network 8 such as the Internet or the like takes out the content purchase certificate recoded in the optical disc 6 with the use of dedicated software and transmits it without decrypting it to the content management center 9 via the external network 8.

The content management center 9 decodes the encrypted content purchase certificate and checks the decoded content purchase certificate on a purchaser database 10 for identification and authentication of the purchaser. Then, printing permission of media label data for the content data which the content management center 9 manages is provided to the connector who is certified as a content purchaser through the authentication operation.

In this provision, when the purchaser database 10 holes the number of times of printing, it can be utilized as information for determining, upon request for re-printing of the media label data from the connector, whether a fee should be imposed on the reprinting. This feature point is applicable to the following embodiments.

When the content purchaser receives the printing permission at the PC 7 from the content management center 9 via the external network 8, he/she sets the optical disc 6 to a printer 11 to allow the printer 11 to print the media label data on a label face of the optical disc 6 in which the content data is recorded. Thus, a label printed optical disc 12 is created.

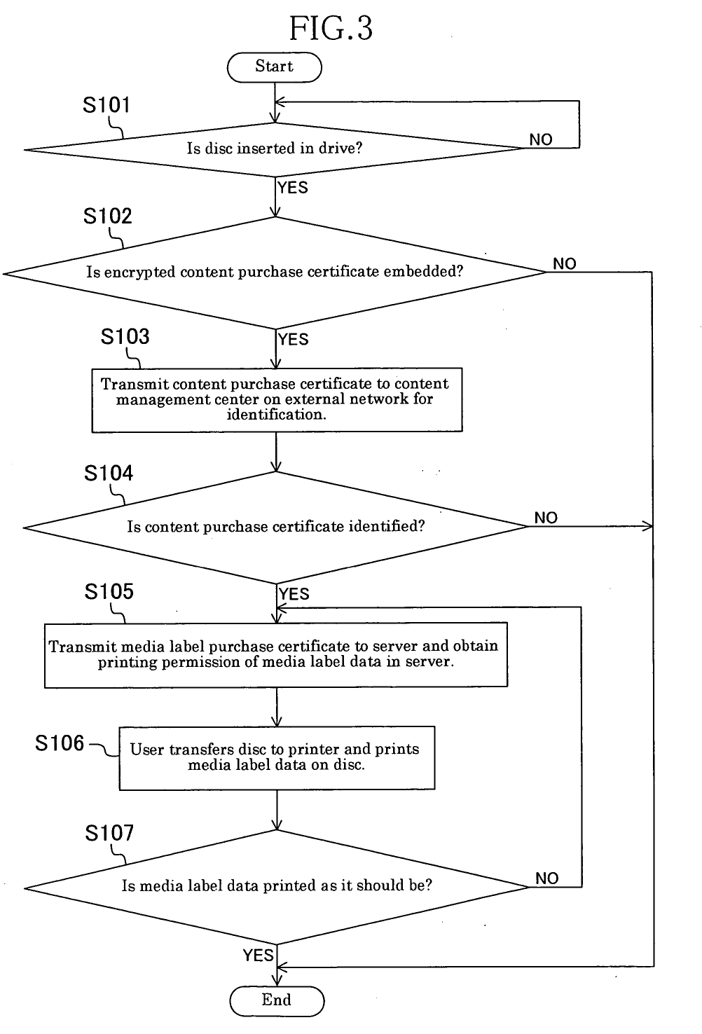

FIG. 3 is a flowchart showing a processing operation of the media label printing system. Specifically, it shows a software algorithm to be performed in a PC for label printing by referencing a content purchase history.

As shown in FIG. 3, first in a step S1O1, whether or not the optical disc 6 is inserted in the drive of the PC 7 is judged.

When the judgment in the step S101 is “YES,” the routine proceeds to a step S102. When the judgment in the step S101 is “NO,” disc insertion is awaited.

In the step S102, judgment is performed as to whether or not the content purchase certificate is embedded in the optical disc 6. When the judgment in the step S102 is “YES,” the routine proceeds to a step S103. Though the content purchase certificate is encrypted, decoding is not performed at this time point. When the judgment in the step S102 is “NO,” the processing terminates.

In the step S103, the encrypted content purchase certificate is transmitted to the content management center 9 on the external network 8 such as the Internet or the like, and then, the routine proceeds to a step S104.

In the step S104, judgment is performed as to whether or not the content purchase certificate is identified. When the judgment in the step S104 is “YES,” the routine proceeds to a step S105. When the judgment in the step S104 is “NO,” the processing terminates.

In the step S105, the media label purchase certificate embedded in the optical disc 6 together with the content purchasing certificate is transmitted to the content management center 9 for obtaining the printing permission, and then, the routine proceeds to a step S106.

In the step S106, the user takes the optical disc 6 out from the drive of the PC 7, sets it to the printer 11 connected to the PC 7, and prints printing-permitted media label data on a label face, and then, the routine proceeds to a step S107.

In the step S107, judgment is performed as to whether or not the media label printing is performed as it should be. When the judgment in the step S107 is “YES,” the processing terminates. When the judgment in the step S107 is “NO,” the routine proceeds to the step S105 for requesting the printing permission of the media label data again.

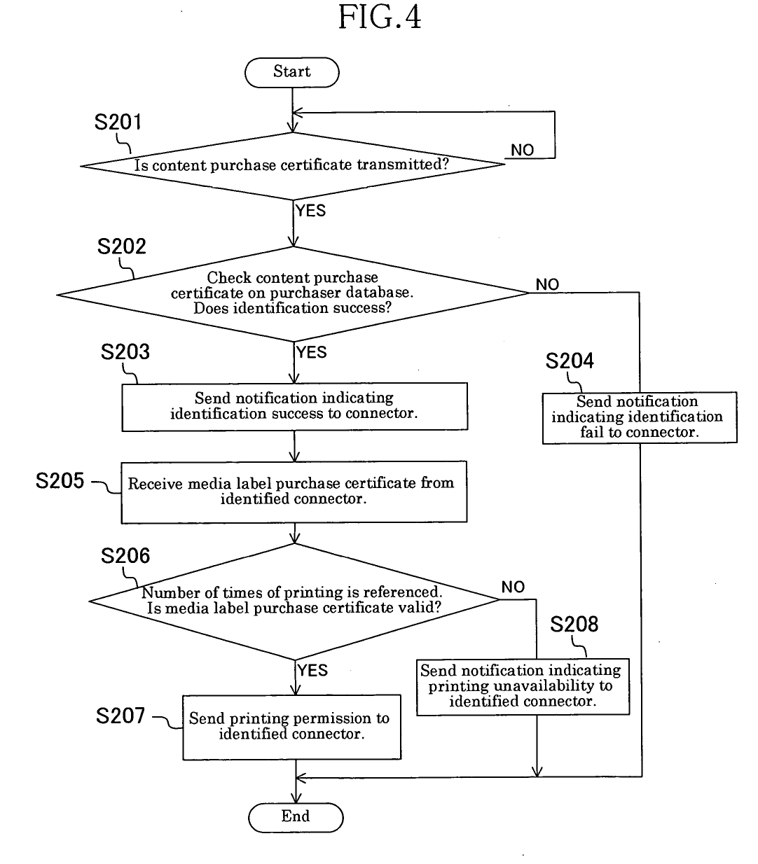

FIG. 4 is a flowchart showing a software algorithm performed in the content management center 9. As shown in FIG. 4, first in a step S201, whether or not a content purchase certificate is received is judged.

When the judgment in the step S201 is “YES,” the routine proceeds to a step S202. When the judgment in the step S201 is “NO,” receipt of a content purchase certificate is awaited.

In the step S202, the received content purchase certificate is checked on the purchaser database 10 for identification and judgment is performed as to the check results in success. When the judgment in the step S202 is “YES,” the routine proceeds to a step S203. When the judgment in the step S202 is “NO,” the routine proceeds to a step S204. In the step S204, a notification of identification fail is sent to a connecter, that is, a transmitter who transmits the content purchase certificate, and then, the processing terminates.

In the step S203, a notification of identification success is sent to the connector, and then, the routine proceeds to a step S205.

In the step S205, a media label purchase certificate is received from the identified connector, and the routine proceeds to a step S206.

In the step S206, the number of times of printing of the media label data of which media label purchase certificate is received is referenced for judging whether or not the media label purchase certificate is valid, the number thereof being recorded in the purchaser database 10.

When the judgment in the step S206 is “YES,” the routine proceeds to a step S207. In the step S207, the printing permission is sent to the identified connector, and then, the processing terminates. When the judgment in the step S206 is “NO,” the routine proceeds to a step S208. In the step S208, printing unavailability is notified to the identified connector.

In Embodiment 1, the case where the media label data is purchased together with the content data is described. However, the present invention is not limited thereto, and it is possible, for example, that for user's content data purchase, fee information of media label data for the content data is presented in a display device (not shown) together with fee information of the content data so as to enable the user to optionally select whether to purchase the media label data including the media label purchase certificate.

(Embodiment 2)

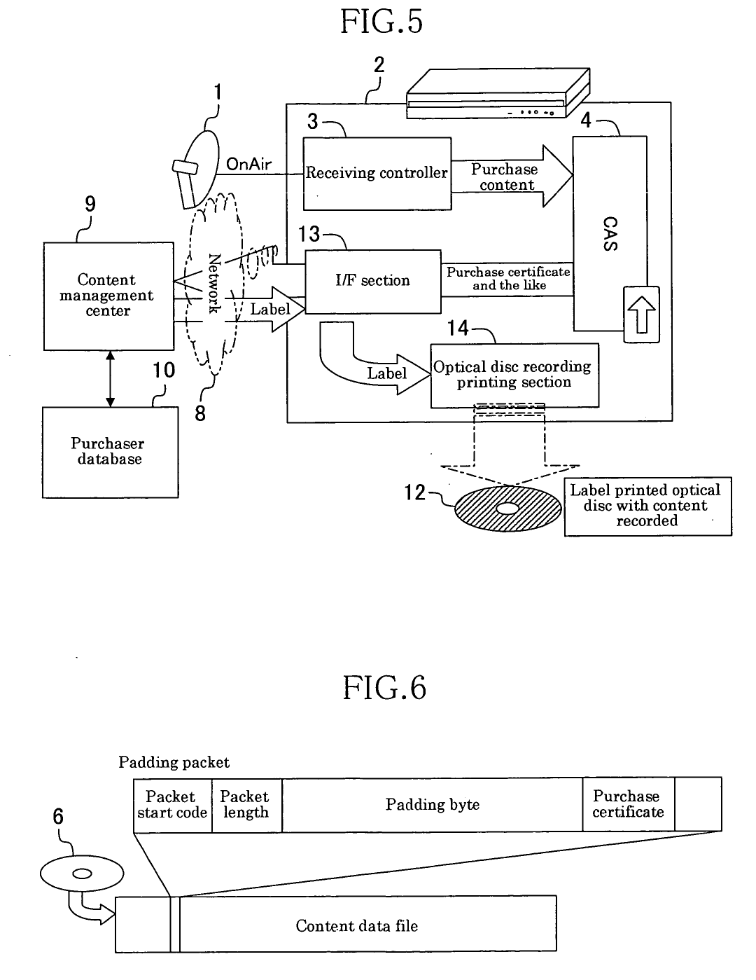

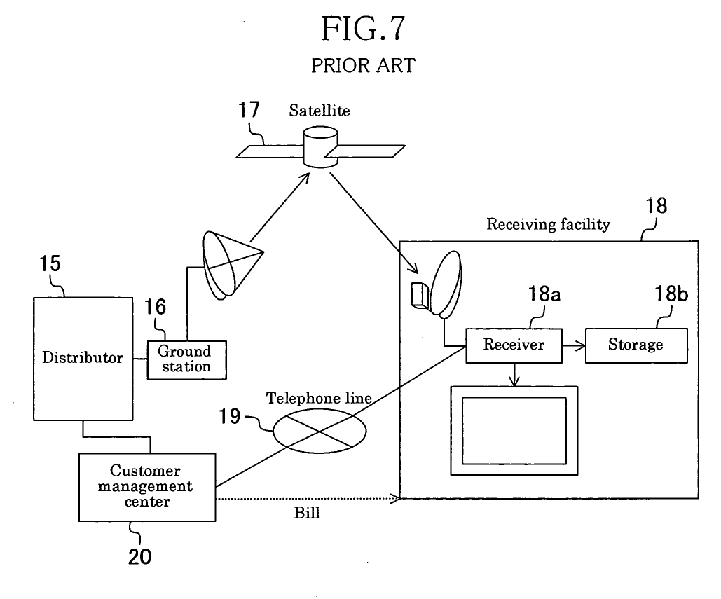

FIG. 5 is a block diagram showing a configuration of a media label distribution system according to Embodiment 2 of the present invention. Difference from Embodiment 1 lies in that the media label printing system is incorporated in the media recording system. Therefore, only the difference will be described below with the same reference numerals assigned to the same elements.

As shown in FIG. 5, in the recorder 2, the receiving controller 3 extracts key information from a pay broadcast program received in the broadcast wave receiver 1 and transmits it to the CAS 4 for descrambling the key information.

When the key information is obtained through receipt of the pay broadcast program and transmission of the key information to the CAS 4, a response thereof is held which indicates that purchase of content data of the pay broadcast program and media label data has been done. The response as a content purchase certificate is transmitted to an I/F section 13 to transmit it to the content management center 9 via the external network 8 such as the Internet or the like. While in an optical disc recording printing section 14, the content purchase certificate is recorded together with the content data to the optical disc 6 so as not to involve any influence on reproduction of any contents in the optical disc 6.

The content management center 9 decodes the encrypted content purchase certificate and checks the decoded content purchase certificate on the purchaser database 10 for identification and authentication of the purchaser. Then, printing permission of the media label data managed in the content management center 9 is provided to the connector identified through authentication as a purchaser of the media content.

Upon receipt of the printing permission, the recorder 2 transmits the media label data from the I/F section 13 to the optical disc recording printing section 14, and the optical disc recording printing section 14 prints the media label data on the label face of the optical disc. Thus, the label printed optical disc 12 is created.

As described above, the present invention exhibits a practically excellent effect of efficient distribution of media label data to content purchasers, and therefore, is much useful and applicable in industries. Particularly, the present invention is useful in systems for content distribution on a network.

What is claimed is:

1. A content recording method comprising:
a content purchase certificate obtaining step of obtaining a content purchase certificate indicating that a user has purchased content data; and
a recording step of recording the content purchase certificate to a content recording medium together with the content data.

2. The content recording method of claim 1, further comprising:
a media label purchase certificate obtaining step of obtaining, in a case where pay media label data is distributed for the content data, a media label purchase certificate indicating that the user has purchased the media label data,
wherein in the recording step, the content purchase certificate and the media label purchase certificate are recorded to the content recording medium together with the content data.

3. The content recording method of claim 1,
wherein a conditional access system, which allows only a subscriber who establishes a contract for a pay broadcast program to view and listen to the content data, stores fee information of the content data and fee information of media label data for the content data,
the method further comprising the step of:
presenting to the subscriber, when the subscriber purchases the content data, the fee information of the media label data together with the fee information of the content data so as to enable the subscriber to select whether or not to purchase the media label data accompanying a media label purchase certificate by referencing the presented information.

4. The content recording method of claim 2, further comprising the step of:
concealing by embedding the content purchase certificate or the media label purchase certificate in a padding packet located in a range within a predetermine number of bytes from the top of the content data.

5. A media label distribution method, comprising the steps of:
extracting a content purchase certificate or a media label purchase certificate from a content recording medium in which data is recorded by the content recording method of claim 2;
transmitting the extracted content purchase certificate or the extracted media label purchase certificate to a content management center via an external network; and
performing user identification in the content management center on the basis of the content purchase certificate or the media label purchase certificate.

6. The media label distribution method of claim 5, further comprising the step of:
providing to the identified user printing permission of the media label.

7. The media label distribution method of claim 6, further comprising the step of:
judging, while counting the number of times of printing of the media label data, whether or not to provide printing permission of the media label data on the basis of the counted number of times of printing.

8. The media label distribution method of claim 6, further comprising the step of:
judging, while counting the number of times of printing of the media label data, whether or not to impose a printing fee for the media label data on the basis of the counted number of times of printing.

9. A content recording system comprising:
means for obtaining a content purchase certificate indicating that a user has purchased content data; and
means for recording the content purchase certificate to a content recording medium together with the content data.

10. The content recording system of claim 9, further comprising:
means for obtaining, in a case where pay media label data is distributed for the content data, a media label purchase certificate indicating that the user has purchased the media label data,
wherein the recording means records the content purchase certificate and the media label purchase certificate to the content recording medium together with the content data.

11. The content recording system of claim 9, further comprising:
a conditional access system, which allows only a subscriber who establishes a contract for a pay broadcast program to view and listen to the content data, for storing fee information of the content data and fee information of media label data for the content data; and
means for presenting to the subscriber, when the subscriber purchases the content data, the fee information of the media label data together with the fee information of the content data so as to enable the subscriber to select whether or not to purchase the media label data accompanying a media label purchase certificate by referencing the presented information.

12. The content recording system of claim 10, further comprising:
means for concealing by embedding the content purchase certificate or the media label purchase certificate in a padding packet located in a range within a predetermine number of bytes from the top of the content data.

13. A media label distribution system comprising:
means for extracting a content purchase certificate or a media label purchase certificate from a content recording medium in which data is recorded by the content recording system of claim 10;
means for transmitting the thus extracted content purchase certificate or the thus extracted media label purchase certificate to a content management center via an external network; and
means for performing user identification in the content management center on the basis of the content purchase certificate or the media label purchase certificate.

14. The media label distribution system of claim 13, further comprising:
means for providing to the identified user printing permission of the media label data.

15. The media label distribution system of claim 14, further comprising:
means for judging, while counting the number of times of printing of the media label data, whether or not to provide printing permission of the media label data on the basis of the counted number of times of printing.

16. The media label distribution system of claim 14, further comprising:
means for judging, while counting the number of times of printing of the media label data, whether or not to impose a printing fee for the media label data on the basis of the counted number of times of printing.

17. A media label distribution system comprising:
means for receiving content data;
means for transmitting a content purchase certificate indicating that the received content data has been purchased to a content management center via an external network;
means for providing printing permission of media label data for the content data to a user identified as a purchaser of the content data by referencing the content purchase certificate in the content management center;
means for recording the content data to a content recording medium; and
means for printing the media label data on a label surface of the content recording medium.
